(19) United States
(12) Patent Application Publication
(10) Pub. No.: US 2026/0043949 A1
(43) Pub. Date: Feb. 12, 2026

(54) LENS ARRAY WITH MEASUREMENT STRUCTURES

(71) Applicant: Young Optics Inc., Hsinchu Science Park (TW)

(72) Inventors: Shih-Chang LIU, Hsinchu Science Park (TW); Cheng-Chi KU, Hsinchu Science Park (TW); Kai-Wei HU, Hsinchu Science Park (TW)

(21) Appl. No.: 19/020,377

(22) Filed: Jan. 14, 2025

(30) Foreign Application Priority Data
Aug. 8, 2024 (TW) 113129836

(51) Int. Cl. G02B 3/00

(52) U.S. Cl. CPC G02B 3/0075; G02B 2003/0093

(57) ABSTRACT

A lens array with measurement structures includes a first lens surface and a second lens surface opposite to each other and arranged along a first direction. The first lens surface has a first feature structure, a second feature structure and a third feature structure, and the second lens surface has a fourth feature structure, a fifth feature structure and a sixth feature structure corresponding respectively to the first feature structure, the second feature structure and the third feature structure. A shape center of the first feature structure is offset from that of the fourth feature structure, a shape center of the second feature structure is offset from that of the fifth feature structure, and a shape center of the third feature structure is offset from that of a sixth feature structure relative to the first direction.

### CROSS-REFERENCE TO RELATED APPLICATION

This application claims the priority benefit of Taiwan application serial no. 113129836, filed Aug. 8, 2024. The entirety of the above-mentioned patent application is hereby incorporated by reference herein and made a part of this specification.

### BACKGROUND

### Field of the Invention

The invention relates to a lens array, and more particularly to a lens array with measurement structures for correcting axial misalignment errors.

### Description of the Related Art

Microlens arrays fabricated using molds are susceptible to optical decenter errors as a result of axial misalignment. Due to the small size and typically square shape of the microlenses, it is difficult for conventional contact-type or optical measurement equipment to accurately measure the actual axial misalignment values. For example, a commonly used TRIOPTICS® collimator can measure optical decenter errors; however, the measurement and calibration process is time-consuming, and the resulting values often show significant variability, failing to meet the requirements for high-efficiency and high-precision measurements. Alternatively, the axial misalignment of microlens arrays can be estimated based on the mold's precision. Nevertheless, this approach cannot guarantee the acquisition of actual axial misalignment values, nor does it allow for adjustments to the mold's precision based on measured data.

### BRIEF SUMMARY OF THE INVENTION

In order to achieve one or a portion of or all of the objects or other objects, one embodiment of the invention provides a lens array with measurement structures including a first lens surface and a second lens surface opposite to each other and arranged along a first direction. The first lens surface has a first feature structure, a second feature structure and a third feature structure, and the second lens surface has a fourth feature structure, a fifth feature structure and a sixth feature structure corresponding respectively to the first feature structure, the second feature structure and the third feature structure. Each of the first, the second, the third, the fourth, the fifth and the sixth feature structures defines a shape center, a shape center of the first feature structure is offset from a shape center of the fourth feature structure relative to the first direction, a shape center of the second feature structure is offset from a shape center of the fifth feature structure relative to the first direction, and a shape center of the third feature structure is offset from the shape center of a sixth feature structure relative to the first direction.

Another embodiment of the invention provides a lens array including a first lens surface and a second lens surface opposite to each other and arranged along a first direction. A first structure, a second structure, and a third structure are disposed on the first lens surface and outside an optically active area of the first lens surface. A fourth structure, a fifth structure, and a sixth structure are disposed on the second lens surface and outside an optically active area of the second lens surface. The first structure corresponds to the fourth structure along the first direction, the first structure and the fourth structure are configured to have distinguishable measurement edges with respect to the first direction, the second structure corresponds to the fifth structure along the first direction, the second structure and the fifth structure are configured to have distinguishable measurement edges with respect to the first direction, the third structure corresponds to the sixth structure along the first direction, and the third structure and the sixth structure are configured to have distinguishable measurement edges with respect to the first direction.

Through the design of the embodiments, because at least three feature structures measurable by an image measuring instrument are provided on both the first lens surface and the second lens surface of the lens array, optical decenter error values between the two opposing lens surfaces can be quickly obtained without the need to move or flip the lens array. The obtained misalignment value can then be used to adjust or modify the precision of the mold, effectively correcting the optical decenter error of the final lens array product. Consequently, precise and efficient measurement of actual axial misalignment errors may be achieved without using optical measurement equipment such as a collimator or contact-type measurement equipment. This simplifies the process of correcting optical decenter errors in lens arrays, reduces measurement time, and lowers equipment costs.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a lens array according to an embodiment of the invention.

FIG. 2A and FIG. 2B are schematic diagrams respectively illustrating the arrangement of measurement structures on two opposite lens surfaces of a lens array according to an embodiment of the invention.

FIG. 3 shows a schematic diagram of a mold core with feature structures for fabricating a lens array according to an embodiment of the invention.

FIG. 4 is a schematic diagram illustrating the correction of optical decenter errors using feature structures according to an embodiment of the invention.

FIG. 5 is a schematic diagram showing the arrangement of feature structures on the lens surface according to an embodiment of the invention.

FIG. 6 is a schematic diagram showing the arrangement of feature structures on the lens surface according to another embodiment of the invention.

FIG. 7 is a schematic diagram showing the arrangement of feature structures on the lens surface according to another embodiment of the invention.

FIG. 8 is a schematic diagram showing the arrangement of feature structures on the lens surface according to another embodiment of the invention.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc, as used herein, are used as labels for nouns that they precede, and do not imply any type of ordering (e.g., spatial, temporal, logical, etc.).

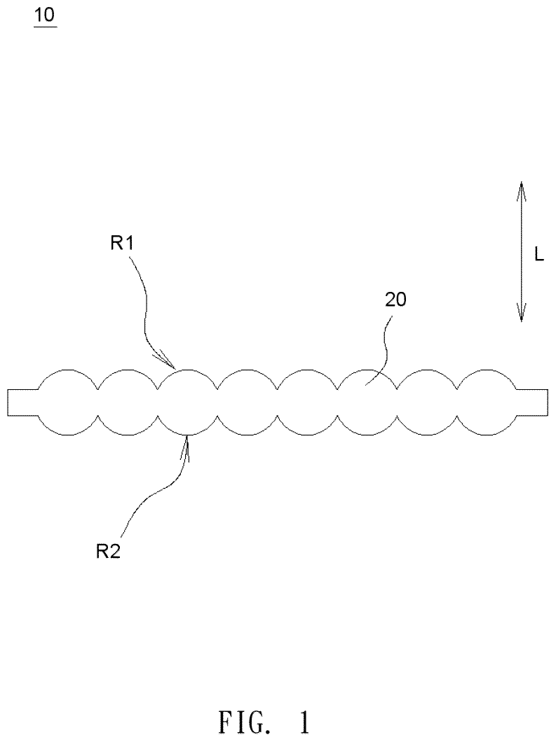

FIG. 1 shows a schematic diagram of a lens array according to an embodiment of the invention. Referring to FIG. 1, a lens array 10 includes multiple microlens elements 20 and has corresponding lens surfaces R1 and R2 that are opposite to each other and arranged along a direction (e.g., vertical direction L). The lens surface R1 may function as a light-emitting surface of the lens array 10, and the lens surface R2 may function as a light-incident surface, or vice versa, depending on the application scenario and optical design. Additionally, in relation to the vertical direction L shown in FIG. 1, the lens surface R1 is positioned as the upper surface of the lens array 10, while the lens surface R2 is positioned as the corresponding lower surface. For instance, when the lens surface R1 functions as the light-emitting surface and the lens surface R2 functions as the light-incident surface, the lens surface R2 may divide an uneven incident light spot into an array of sub-spots, and each sub-spot is then individually focused onto the corresponding position on the lens surface R1. Subsequently, these sub-spots are scaled based on the shape of the lens surface R1 and are superimposed at the same position with a uniform size, resulting in homogenized light energy distribution and refined light patterns.

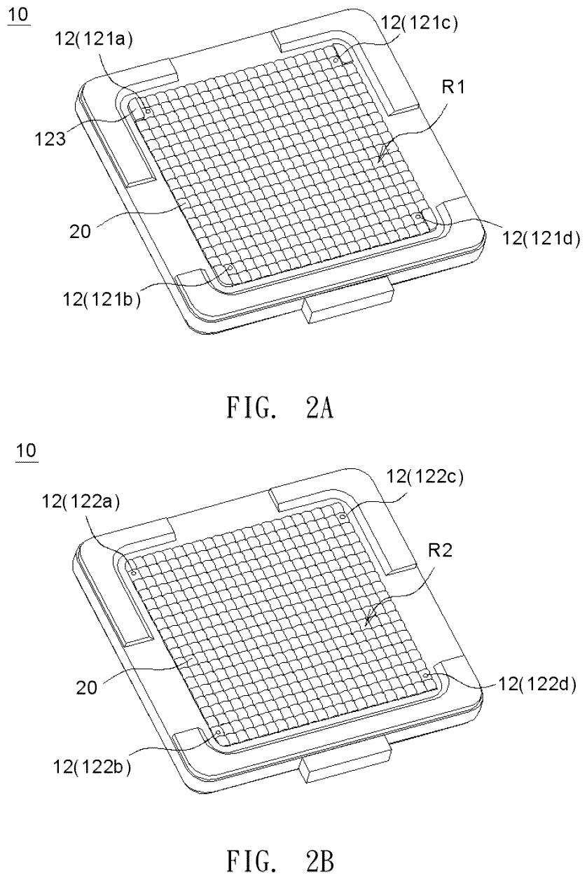

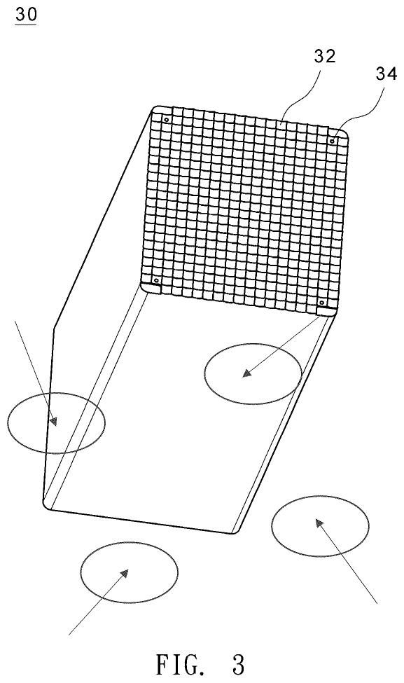

FIG. 2A and FIG. 2B are schematic diagrams respectively illustrating the arrangement of measurement structures on the lens surface R1 and the lens surface R2 of the lens array 10 according to an embodiment of the invention. In this embodiment, the microlens elements 20 are arranged in multiple rows, and several feature structures 12 are formed on the microlens elements 20 to serve as axial misalignment measurement structures. In this embodiment, four feature structures 121a, 121b, 121c and 121d are disposed around the lens surface R1 (FIG. 2A), and four feature structures 122a, 122b, 122c and 122d are arranged around lens surface R2 (FIG. 2B). However, the invention is not limited to this specific arrangement. Furthermore, in this embodiment, the feature structures 121a-121d and 122a-122d are disposed outside the optically active area of the lens array 10, and each of the feature structures 12 is formed on one of the microlens elements 20, but the invention is limited thereto.

FIG. 3 shows a schematic diagram of a mold core with feature structures for fabricating a lens array according to an embodiment of the invention. In this embodiment, the mold core 30 shown in FIG. 3 is an upper mold core designed to form the lens surface R1. As illustrated in FIG. 3, the microlens elements 32 and feature structures 34 on the mold core 30 are fabricated simultaneously to ensure the relative positional accuracy of the microlens elements 32 and the feature structures 34. Since the mold core 30 is used to mold the lens array 10, the microlens elements 20 and the feature structures 12 on the lens array 10 correspond in position and are complementary in shape to the microlens elements 32 and the feature structures 34 on the mold core 30. For instance, if the feature structure 34 of the mold core 30 is a recessed structure, the corresponding feature structure 12 on the molded lens array 10 will be a protruding structure.

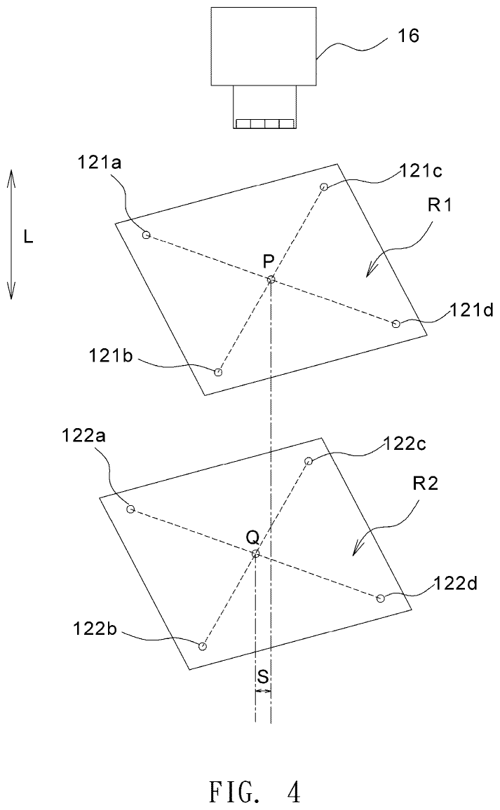

FIG. 4 is a schematic diagram illustrating the correction of optical decenter errors using feature structures according to an embodiment of the invention. As shown in FIG. 4, an image measuring device 16 may capture images of the lens surfaces R1 and R2 of the lens array 10 to obtain positional information for the four feature structures 121a-121d on lens surface R1 and the four feature structures 122a-122d on the lens surface R2. In this embodiment, along the vertical direction L, the feature structures 121a, 121b, 121c and 121d on the lens surface R1 correspond respectively to the feature structures 122a, 122b, 122c and 122d on the lens surface R2. In one embodiment, the feature structure 122a, which corresponds to the feature structure 121a on the lens surface R1, is closest to feature structure 121a among all the feature structures 122a, 122b, 122c, and 122d on the lens surface R2, and so forth for the remaining feature structures. Based on the positions of the feature structures 121a to 121d, a central point P of the lens surface R1 can be determined, and similarly, a central point Q of the lens surface R2 can be determined based on the positions of the feature structures 122a to 122d. In this case, the central point P represents the position of the lens surface R1, and the central point Q represents the position of the lens surface R2. The distance S, which measures the separation between the central points P and Q along the vertical axis L, indicates the actual optical decenter error as a result of axial misalignment between the lens surfaces R1 and R2. After determining the optical decenter error value, corrective measures can be implemented on the upper and lower mold cores, such as adjusting the mold spacer thickness or applying ultra-precision machining techniques, to effectively minimize the optical decenter error in the final lens array product. In various embodiments of the invention, forming at least three feature structures on each lens surface is sufficient to define a measurement plane corresponding to that lens surface. The relative displacement between two measurement planes can then be determined based on the positions of these feature structures.

Through the design of the above embodiments, the presence of at least three measurable feature structure, which can be detected by an image measuring device, on both the first and second lens surfaces of the lens array allows for the rapid acquisition of optical decenter errors between the two opposing lens surfaces without moving or flipping the lens array. The obtained misalignment value can then be used to adjust or modify the precision of the mold, effectively correcting the optical decenter error of the final lens array product. Consequently, precise and efficient measurement of actual optical decenter errors may be achieved without using optical measurement equipment such as a collimator or contact-type measurement equipment. This simplifies the process of correcting optical decenter errors in lens arrays, reduces measurement time, and lowers equipment costs.

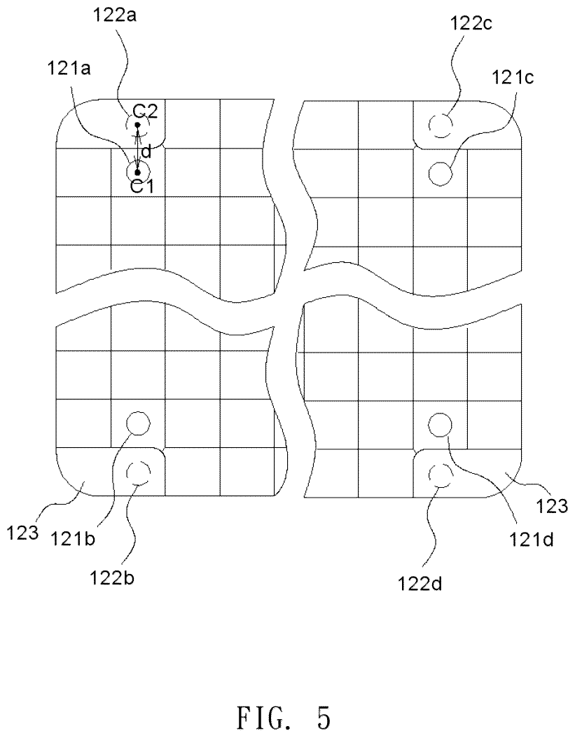

In various embodiments of the invention, each feature structure 12 is only required to define a shape center and is not limited to a specific form; for example, the feature structure 12 may be circular, polygonal, or annular. FIG. 5 is a schematic diagram showing the arrangement of feature structures on the lens surface according to an embodiment of the invention. In this embodiment, the feature structures 121a-121d on the upper lens surface R1 of the lens array are substantially identical in size and shape to the feature structures 122a-122d on the lower lens surface R2. Each feature structure 12 has a shape center (e.g., shape center C1 or C2), and the positions of these shape centers can be used to calculate respective central points P and Q of the lens surfaces R1 and R2 as previously described. In this embodiment, the feature structures 121a, 121b, 121c, and 121d on the upper lens surface R1 correspond to the feature structures 122a, 122b, 122c, and 122d on the lower lens surface R2, respectively. The corresponding feature structures have an offset relative to the vertical direction (perpendicular to lens surfaces R1 and R2). For example, as shown in FIG. 5 with reference to FIG. 4, feature structure 121a on the upper lens surface R1 corresponds to the nearest feature structure 122a on the lower lens surface R2, and the shape center C2 of the feature structure 122a is offset relative to the vertical direction L from the shape center C1 of the feature structure 121a by a distance d. That is, a line passing through the shape center C2 and extending in the vertical direction L is spaced apart from a line passing through the shape center C1 and extending in the vertical direction L by the distance d. Since the image measuring instrument 16 captures images along a vertical shooting direction (e.g., from top to bottom), the obtained image simultaneously includes the feature structures on both the upper lens surface R1 and the lower lens surface R2. In this case, the offset design of corresponding feature structures relative to the vertical direction ensures that the feature structures 121a-121d on the upper lens surface R1 and the feature structures 122a-122d on the lower lens surface R2 can be distinguished, allowing for the respective calculation of central points of lens surfaces to obtain relative axial misalignment. Furthermore, referring to FIG. 2A, FIG. 2B and FIG. 5, in this embodiment, each of the feature structures 122a-122d on the lower lens surface R2 is positioned to coincide with a planer block 123 on the upper lens surface R1. This arrangement may enhance the quality of images captured by the image measuring instrument 16, but the invention is not limited thereto.

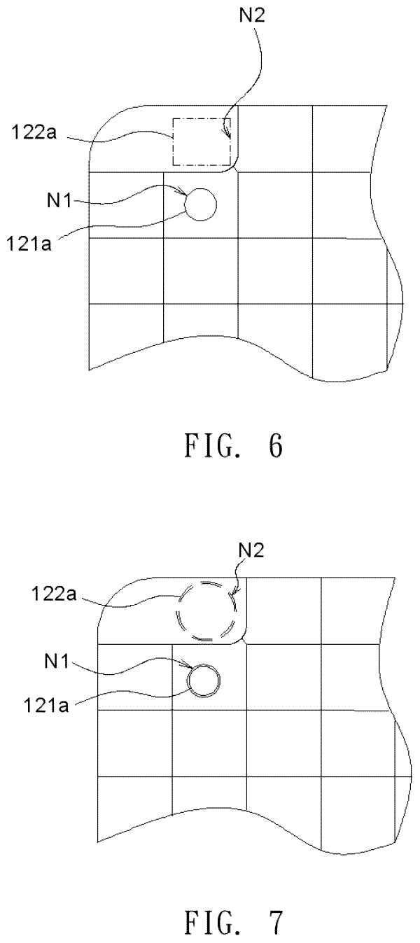

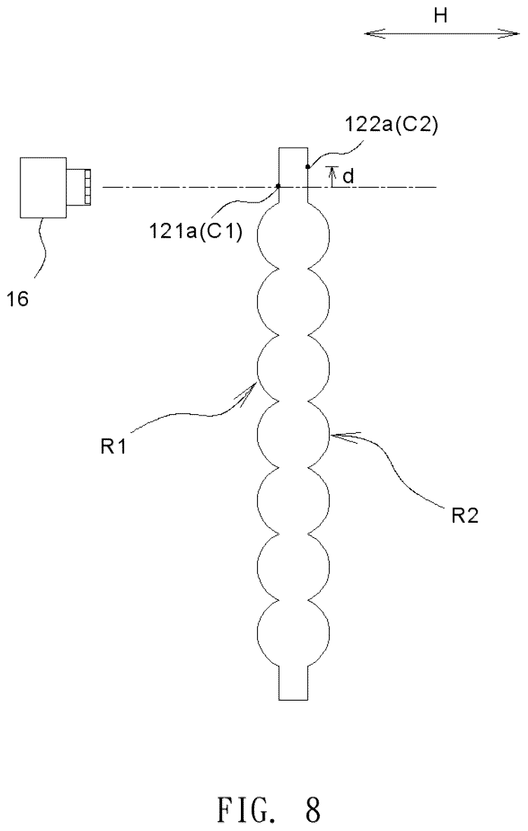

In other embodiments, different shapes or sizes may be used to distinguish feature structures on different lens surfaces. As shown in FIG. 6, for example, feature structure 121a on the upper lens surface R1 may be circular, and feature structure 122a on the lower lens surface R2 may be rectangular. With this configuration, feature structures 121a and 122a may respectively provide distinguishable measurement edges N1 and N2 when viewed along the vertical shooting direction of the image measuring instrument 16. Here, “measurement edge” refers to an edge or contour line that can be detected by the image measuring instrument to define a shape center. The measurement edge may be continuous, discontinuous, form a closed shape, or appear as a line segment without limitation. In another embodiment, as shown in FIG. 7, the feature structure 121a on the upper lens surface R1 is a smaller annular microstructure, and the feature structure 122a on the lower lens surface R2 is a larger annular microstructure. By configuring different sizes, feature structures 121a and 122a may also form distinguishable measurement edges N1 and N2 with respect to the vertical shooting direction. Furthermore, the offset design of corresponding feature structures relative to the vertical direction L is provided as an example and is not limiting. As shown in FIG. 8, in other embodiment, the lens array may be configured with lens surfaces R1 and R2 arranged along a horizontal direction H. In this case, since the image measuring instrument 16 captures images along a horizontal shooting direction, the shape center C2 of feature structure 122a is designed to have an offset relative to the horizontal direction H from the shape center C1 of feature structure 121a by a distance d. In other words, in various embodiments of the invention, two corresponding feature structures may be offset in different directions based on the imaging direction of the measuring instrument and the arrangement direction of the lens surfaces, without being limited to a specific direction.

Based on the above, the lens array with measurement structures according to the above embodiments has at least one of the following advantages. Because at least three feature structures measurable by an image measuring instrument are provided on both the first lens surface and the second lens surface of the lens array, optical decenter error values between the two opposing lens surfaces can be quickly obtained without the need to move or flip the lens array. The obtained misalignment value can then be used to adjust or modify the precision of the mold, effectively correcting the optical decenter error of the final lens array product. Consequently, precise and efficient measurement of actual optical decenter errors may be achieved without using optical measurement equipment such as a collimator or contact-type measurement equipment. This simplifies the process of correcting axial misalignment errors in lens arrays, reduces measurement time, and lowers equipment costs.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. A lens array with measurement structures, comprising:
a first lens surface and a second lens surface opposite to each other and arranged along a first direction, the first lens surface has a first feature structure, a second feature structure and a third feature structure, the second lens surface has a fourth feature structure, a fifth feature structure and a sixth feature structure corresponding respectively to the first feature structure, the second feature structure and the third feature structure, wherein each of the first, the second, the third, the fourth, the fifth and the sixth feature structures defines a shape center, a shape center of the first feature structure is offset from a shape center of the fourth feature structure relative to the first direction, a shape center of the second feature structure is offset from a shape center of the fifth feature structure relative to the first direction, and a shape center of the third feature structure is offset from the shape center of a sixth feature structure relative to the first direction.

2. The lens array as claimed in claim 1, wherein each of the first, the second, the third, the fourth, the fifth and the sixth feature structures is disposed outside an optically active area of the lens array.

3. The lens array as claimed in claim 1, further comprising:
a plurality of microlens elements, wherein each of the first, the second, the third, the fourth, the fifth and the sixth feature structures is formed on one of the microlens elements.

4. The lens array as claimed in claim 1, wherein the feature structures disposed on the first lens surface and the feature structures disposed on the second lens surface have the same shape but different sizes.

5. The lens array as claimed in claim 1, wherein the feature structures disposed on the first lens surface and the feature structures disposed on the second lens surface have different shapes but the same size.

6. The lens array as claimed in claim 1, wherein the first, the second, the third, the fourth, the fifth and the sixth feature structures are circular, polygonal, or annular.

7. A lens array, comprising:
a first lens surface and a second lens surface opposite to each other and arranged along a first direction;
a first structure, a second structure, and a third structure disposed on the first lens surface and outside an optically active area of the first lens surface; and
a fourth structure, a fifth structure, and a sixth structure disposed on the second lens surface and outside an optically active area of the second lens surface;
wherein the first structure corresponds to the fourth structure along the first direction, the first structure and the fourth structure are configured to have distinguishable measurement edges with respect to the first direction, the second structure corresponds to the fifth structure along the first direction, the second structure and the fifth structure are configured to have distinguishable measurement edges with respect to the first direction, the third structure corresponds to the sixth structure along the first direction, and the third structure and the sixth structure are configured to have distinguishable measurement edges with respect to the first direction.

8. The lens array as claimed in claim 7, wherein the structures disposed on the first lens surface and the structures disposed on the second lens surface have the same shape but different sizes.

9. The lens array as claimed in claim 7, wherein the structures disposed on the first lens surface and the structures disposed on the second lens surface have different shapes but the same size.

10. The lens array as claimed in claim 7, wherein a distance between the shape centers of two corresponding offset structures relative to the first direction is at least 0.05 mm.

11. The lens array as claimed in claim 7, wherein the first, the second, the third, the fourth, the fifth and the sixth structures are circular, polygonal, or annular.

12. The lens array as claimed in claim 7, further comprising:
a plurality of microlens elements, wherein each of the first, the second, the third, the fourth, the fifth and the sixth structures is formed on one of the microlens elements.
